(19) United States
(12) Patent Application Publication
(10) Pub. No.: US 2025/0183285 A1
(43) Pub. Date: Jun. 5, 2025

(54) NEGATIVE ELECTRODE MATERIAL FOR LITHIUM ION SECONDARY BATTERY, NEGATIVE ELECTRODE FOR LITHIUM ION SECONDARY BATTERY, AND LITHIUM ION SECONDARY BATTERY

(71) Applicant: TDK Corporation, Tokyo (JP)

(72) Inventors: Shin FUJITA, Tokyo (JP); Takashi MORI, Tokyo (JP)

(73) Assignee: TDK Corporation, Tokyo (JP)

(21) Appl. No.: 19/045,826

(22) Filed: Feb. 5, 2025

Related U.S. Application Data
(63) Continuation of application No. PCT/JP2023/000725, filed on Jan. 13, 2023.

(51) Int. Cl. H01M 4/485; H01M 4/02; H01M 4/36; H01M 10/0525

(52) U.S. Cl. CPC H01M 4/485; H01M 4/366; H01M 2004/021; H01M 10/0525

(57) ABSTRACT

There is provided an anode material for a lithium ion secondary battery, which includes silicon particles. The silicon particles have an average particle diameter of 0.1 μm to 10 μm and an oxygen content of 0.1 wt % or more and 8 wt % or less. In a case where a surface of the silicon particles is analyzed using X-ray photoelectron spectroscopy, an integrated intensity ratio obtained by dividing an integrated intensity of a SiO₂ peak by an integrated intensity of a Si peak is 0.4 or more and 3.0 or less.

### CROSS-REFERENCE TO RELATED APPLICATION

The present application is a continuation of PCT/JP2023/000725, filed on Jan. 13, 2023, the entire contents of which are incorporated herein by reference.

### TECHNICAL FIELD

The present disclosure relates to a negative electrode material for a lithium ion secondary battery, a negative electrode for a lithium ion secondary battery, and a lithium ion secondary battery.

### BACKGROUND

A lithium ion secondary battery is widely used as a power source for a mobile device such as a mobile phone or a notebook computer, a hybrid car, or the like.

The capacity of the lithium ion secondary battery mainly depends on the active material of the electrode. Graphite is generally used as the negative electrode active material. However, there is a demand for a negative electrode active material that provides a higher capacity. Therefore, silicon (Si), which has a much larger theoretical capacity as compared with the theoretical capacity of graphite (372 mAh/g), has attracted attention.

A negative electrode active material containing silicon undergoes a large volume expansion during charging. The volume expansion of the negative electrode active material causes the deterioration of the cycle characteristics of the battery. In a case where the volume expansion of the negative electrode active material occurs, the decomposition or the like of the electrolytic solution occurs since, for example, the negative electrode active material is damaged, the conductive path between the negative electrode active material layers is cut, peeling occurs at the interface between the negative electrode active material layer and the current collector, or cracking occurs in the solid electrolyte interphase (SEI) film. These deteriorate the cycle characteristics of the battery.

For example, Patent Document 1 describes that the cycle characteristics are improved by specifying the aspect ratio of silicon particles and the tilt angle of silicon particles with respect to the current collector.

### CITATION LIST

### Patent Document

[Patent Document 1] Japanese Unexamined Patent Application, First Publication No. 2019-149333

### SUMMARY

Cycle characteristics are an important parameter, and it is desired to improve cycle characteristics using a method other than the method described in Patent Document 1.

Some embodiments of the present disclosure have been made in consideration of the above problems, and an object of the present disclosure is to provide a lithium ion secondary battery having excellent cycle characteristics.

### Solutions

In order to address the above issues, the following is provided.

(1) A negative electrode material for a lithium ion secondary battery according to a first aspect includes silicon particles. The silicon particles have an average particle diameter of 0.1 μm to 10 μm and an oxygen content of 0.1 wt % or more and 8 wt % or less. In a case where a surface of the silicon particles is analyzed using X-ray photoelectron spectroscopy, an integrated intensity ratio obtained by dividing an integrated intensity of a SiO₂ peak by an integrated intensity of a Si peak is 0.4 or more and 3.0 or less.

(2) In the negative electrode material for a lithium ion secondary battery according to the above-described aspect, the integrated intensity ratio may be 0.6 or more and 1.5 or less.

(3) In the negative electrode material for a lithium ion secondary battery according to the above-described aspect, the silicon particles may have an average circularity of 0.920 or more and 0.985 or less and an average aspect ratio of 0.80 or more and 0.97 or less.

(4) In the negative electrode material for a lithium ion secondary battery according to the above-described aspect, the silicon particles may have an oxide film on the surface. A thickness of the oxide film may be 50 nm or more and 500 nm or less.

(5) In the negative electrode material for a lithium ion secondary battery according to the above-described aspect, a thickness of the oxide film may be 100 nm or more and 300 nm or less.

(6) In the negative electrode material for a lithium ion secondary battery according to the above-described aspect, the silicon particles may have an average particle diameter of 1 μm or more and 7 μm or less.

(7) In the negative electrode material for a lithium ion secondary battery according to the above-described aspect, the silicon particles may have a silicon content of 97% or more and 99% or less.

(8) A negative electrode for a lithium ion secondary battery according to a second aspect contains the negative electrode material for a lithium ion secondary battery according to the above-described aspect.

(9) A lithium-ion rechargeable battery according to a third aspect includes the negative electrode for a lithium ion secondary battery according to the above-described aspect, a positive electrode, and an electrolyte.

### Advantageous Effects

The lithium ion secondary battery using the negative electrode active material for a lithium ion secondary battery according to the above-described aspect has excellent cycle characteristics.

### BRIEF DESCRIPTION OF DRAWINGS

FIG. 1 is a view showing results obtained by measuring the surface of silicon particles according to the first embodiment by X-ray photoelectron spectroscopy.

FIG. 2 is a schematic cross-sectional view of a lithium ion secondary battery according to the first embodiment.

### DESCRIPTION OF EMBODIMENTS

Hereinafter, the embodiments will be described in detail with reference to the drawings as appropriate. The drawings that are used in the following description may show characteristic portions in an enlarged scale for the sake of convenience in order to facilitate the understanding of the characteristics, and thus the dimensional ratios or the like of the respective components may differ from the actual ones. The materials, dimensions, and the like, which are exemplified in the following description, are merely examples, and the present disclosure is not limited thereto. Therefore, an appropriate modification can be made within the scope that does not deviate from the gist of the present disclosure.

### “Negative Electrode Material”

A negative electrode material according to the first embodiment is used in a lithium ion secondary battery, and it may include silicon particles. The negative electrode material according to the first embodiment may function, e.g., as a negative electrode active material.

The silicon particle may be elemental silicon, a silicon alloy, a silicon compound, or a silicon composite substance. The silicon particle may be crystalline or amorphous.

The silicon alloy may be represented by, for example, XₙSi. X may be a cation. Examples of X may include Ba, Mg, Al, Zn, Sn, Ca, V, Cr, Mn, Fe, Co, Ni, Cu, Zn, Ge, Y, Zr, Nb, Mo, W, Au, Ti, Na, and K. n may satisfy 0≤n≤0.5.

The silicon composite body may be, e.g., one that is obtained by coating, with a conductive material, at least a part of the surface of the particle of silicon or a silicon compound. Examples of the conductive material may include a carbon material, Al, Ti, Fe, Ni, Cu, Zn, Ag, and Sn. For example, one example thereof is a silicon carbon composite body material (Si—C).

The silicon content of the silicon particles may be, for example, 97% or more and 99% or less. The silicon content in the silicon particles can be measured, for example, by compositional analysis using a transmission electron microscope (TEM). In a case where TEM is used, a range of distances from the center of the silicon particle to one-third of the particle radius is randomly measured. The silicon content is calculated as the average value obtained from the results of five or more measurements. In a case where the silicon content in the silicon particles is high, the capacity and initial efficiency of the lithium ion secondary battery are high. In addition, in a case where additives are mixed with the silicon particles, it is possible to suppress the volume expansion of silicon during the charging and discharging of a lithium ion secondary battery.

The silicon particles may contain oxygen. Oxygen may be contained in the silicon particles as silicon oxide, which is represented by SiOₓ. For example, a part of the silicon particles may be oxidized. x may satisfy, for example, 0.8≤x≤2.

The oxygen content of the silicon particles may be, for example, 0.1 wt % or more and 8 wt % or less. The oxygen content of the silicon particles is the oxygen content of the entire silicon particles, and it can be measured, for example, by the inert gas fusion-infrared absorption method. Before the measurement, as a pretreatment, a drying treatment is carried out in a temperature range of 80° C. to 100° C.

In a case where silicon particles contain oxygen, lithium silicate is formed during the charging and discharging of a lithium ion secondary battery. Lithium silicate serves as a solid electrolyte interphase (SEI) film. The oxygen contained in silicon particles may affect the quality of the SEI film. Lithium silicate may function as a cushioning material for the expansion and contraction during the charging and discharging of a lithium ion secondary battery. On the other hand, excessive lithium silicate may become a resistance during charging and discharging, which may lead to a decrease in the input-output characteristics of a lithium ion secondary battery. In a case where the oxygen content in the silicon particles is within the above-described range, an appropriate amount of lithium silicate may be formed during the charging and discharging of a lithium ion secondary battery.

Silicon particles may have an oxide film, for example, on the surface thereof. The oxygen that constitutes the oxide film is a part of the oxygen contained in the silicon particles. The oxide film may be, for example, silicon oxide denoted as SiOₓ. The oxide film may not be entirely silicon oxide. For example, even in a case where the oxide film is silicon oxide as a whole, silicon may remain in a part of the oxide film. The thickness of the oxide film may be, for example, 50 nm or more and 500 nm or less, or 100 nm or more and 300 nm or less. The thickness of the oxide film may be, for example, the average value of thicknesses of the oxide film formed on 100 silicon particles, where the thicknesses are determined from a cross-sectional image.

The oxide film on the surface of silicon particles may serve as a cushioning material for the volume expansion of silicon particles during the charging and discharging of a lithium ion secondary battery, and it may help prevent or suppress damage to the silicon particles. In addition, in a case where the thickness of the oxide film is equal to or smaller than a certain value, the film resistance may not become excessively high, and the capacity of the lithium ion secondary battery may increase.

The average particle diameter of the silicon particles may be, e.g., 0.1 μm or more and 10 μm or less, 0.5 μm or more and 8 μm or less, or 1 μm or more and 7 μm or less. In a case where the average particle diameter of the silicon particles is within the above-described ranges, the cycle characteristics are improved. If the silicon particles were to be too small, the contact area between the silicon particles and the electrolytic solution could increase, which could raise the risk of side reactions such as the decomposition of the electrolytic solution. In addition, if the silicon particles were to be too large, there could be an increased risk that side reactions such as the decomposition of the electrolytic solution occur on the newly formed surfaces by the damage to the silicon particles due to expansion and contraction.

In a case where silicon particles are available in a particulate state, the median diameter (D50) can be determined as the average particle diameter using a particle size distribution analyzer (available from, for example, Malvern Panalytical Ltd.). In a case where a particle size distribution analyzer is used, for example, the average particle diameter of 50,000 particles is determined.

In a case where the separation of silicon particles is difficult because they are present within the electrode, the average particle diameter can be determined using at least 100 silicon particles confirmed in a cross-sectional image. The average particle diameter measured using a particle size distribution analyzer and the average particle diameter obtained from a cross-sectional image do not significantly deviate, and they roughly match each other.

First, the threshold of the contrast is set, and binarization is carried out to extract silicon particles (negative electrode material) from the image. Then, the diameter of each of at least 100 silicon particles extracted is determined. The frequency of the determined diameter of each of the silicon particles is graphically shown, and the most frequent value is defined as the average particle diameter. In a case where the shape of the silicon particles is irregular, the diameter of the major axis is used to calculate the average particle diameter.

The average circularity (e.g., sphericity) of the silicon particles may be, e.g., 0.80 or more and 0.99 less, 0.910 or more and 0.988 or less, or 0.920 or more and 0.985 or less.

The average circularity of silicon particles is determined using the circularity of at least 100 or more silicon particles. The circularity is determined by dividing the circumference length of a circle having the same area as the silicon particle as a measurement target by the perimeter of the silicon particle as the measurement target.

Similar to the average particle diameter, the average circularity can be determined using a particle size distribution analyzer in a case where silicon particles are available in a particulate state. In a case where a particle size distribution analyzer is used, for example, the most frequent value of the circularity of 50,000 particles is determined. In addition, in a case where it is difficult to separate the silicon particles, the average circularity can be determined using a cross-sectional image. In a case where a cross-sectional image is used, for example, the circularity of each of the 100 particles is determined. Specifically, silicon particles are extracted from the image, and the perimeter and area of each of the silicon particles are determined. In addition, the circumference length of the circle having the same area as the determined area of each of the silicon particles, and the circularity of each of the silicon particles is calculated. Then, the most frequent value of the circularity of the silicon particles is defined as the average circularity. The average circularity measured using a particle size distribution analyzer and the average circularity obtained from a cross-sectional image do not significantly deviate, and they roughly match each other.

The average aspect ratio of the silicon particles may be, e.g., 0.60 or more and 0.99 or less, 0.65 or more and 0.98 or less, or 0.80 or more and 0.97 or less.

The average aspect ratio of silicon particles is determined using the aspect ratio of at least 100 or more silicon particles. The aspect ratio is determined by dividing the length of the minor axis by the length of the major axis of the silicon particle as a measurement target.

Similar to the average particle diameter, the average aspect ratio can be determined using a particle size distribution analyzer in a case where the silicon particles are available in a particulate state, and it can be determined using a cross-sectional image in a case where it is difficult to separate the silicon particles. In a case where a particle size distribution analyzer is used, for example, the most frequent value of the aspect ratio of 50,000 particles is determined, and In a case where a cross-sectional image is used, for example, the most frequent value of the aspect ratio of 100 particles is determined. The average aspect ratio measured using a particle size distribution analyzer and the average aspect ratio obtained from a cross-sectional image do not significantly deviate, and they roughly match each other.

Here, the silicon particles present in the electrode after charging and discharging the lithium ion secondary battery, and the untreated silicon particles available in a particulate state may not necessarily have the same average particle diameter, average aspect ratio, and average circularity. However, in a case where each of the average particle diameter, the average aspect ratio, and the average circularity, which are obtained by suitable methods, satisfies the above-described ranges, the cycle characteristics of the lithium ion secondary battery may improve in the subsequent charging and discharging.

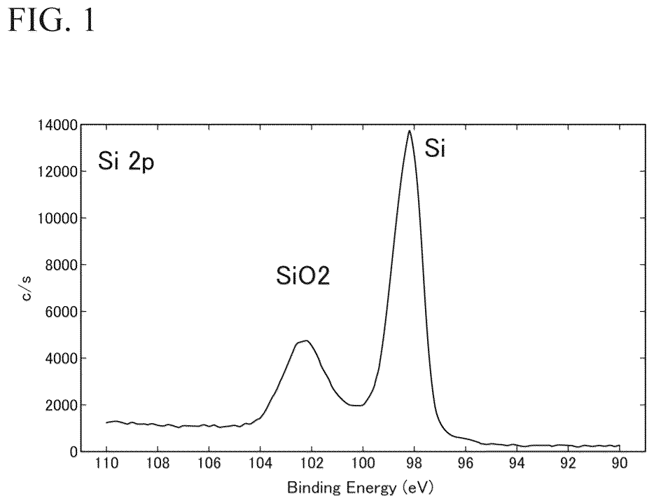

In a case where the surface of silicon particles is analyzed using X-ray photoelectron spectroscopy (XPS), a peak of SiO₂ and a peak of Si may be observed. FIG. 1 shows results obtained by measuring the surface of silicon particles according to the first embodiment by X-ray photoelectron spectroscopy. The XPS spectrum is the Si 2p spectrum. The peak of SiO₂ appears on the high binding energy side with respect to the peak of Si. The peak of Si is observed, for example, between a binding energy of 96 eV and a binding energy of 100 eV. The peak of SiO₂ is observed, for example, between a binding energy of 100 eV and a binding energy of 104 eV. The XPS measurement has been carried out using, for example, a Quantera 2 manufactured by PHI.

In a case where a surface of the silicon particles is analyzed using X-ray photoelectron spectroscopy, an integrated intensity ratio obtained by dividing an integrated intensity of a SiO₂ peak by an integrated intensity of a Si peak may be, e.g., 0.4 or more and 3.0 or less, or 0.6 or more and 1.5 or less. The integrated intensity means the height of the peak top in a case where the number of XPS integrations is 10 or more.

The surface analysis of silicon particles may be carried out, for example, by disassembling a lithium ion secondary battery and extracting silicon particles to measure the surface of the extracted silicon particles. In addition, the surface of the negative electrode may be measured by disassembling the lithium ion secondary battery and extracting the negative electrode. In this case, the information of the binder and the like may also be detected, which can be separated after the data acquisition.

It is not clearly revealed why the cycle characteristics of the lithium ion secondary battery are improved in a case where the integrated intensity ratio obtained using X-ray photoelectron spectroscopy is within the above-described range. It is considered that the cycle characteristics thereof are affected by the following facts: for example, the fact that SiO₂ present on a part of the surface of the silicon particles serves as a cushioning material for the expansion and contraction during the charging and discharging of a lithium ion secondary battery, thereby suppressing the damage to the silicon particles, the fact that SiO₂ present on a part of the surface of the silicon particles prevents direct contact between the electrolytic solution and the silicon, thereby suppressing the decomposition of the electrolytic solution, and the fact that SiO₂ present on a part of the surface of the silicon particles suppresses the generation of lithium silicate during charging and discharging.

In addition, in a case where the inside of the silicon particles is analyzed using X-ray photoelectron spectroscopy, an integrated intensity ratio obtained by dividing an integrated intensity of a SiO₂ peak by an integrated intensity of a Si peak may be, for example, 0.01 or more and 0.5 or less. The integrated intensity ratio inside the silicon particles and the integrated intensity ratio on the surface of the silicon particles are different from each other. The inside of the silicon particles may be in a silicon-rich state as compared with the surface of the silicon particles. In a case where this configuration is satisfied, a lithium ion secondary battery having a high capacity and excellent cycle characteristics can be obtained.

The silicon particles that are used in the negative electrode material according to the first embodiment can be produced, for example, by melting silicon and then solidifying it again. The molten silicon may become rounded due to surface tension. The silicon particles that are used in the negative electrode material according to the first embodiment can be produced, for example, by an atomization method or thermal plasma method. However, the average particle diameter, average circularity, and average aspect ratio of the silicon particles may change depending on the conditions under which they are produced by these methods. In order to make the shape of the silicon particles into a predetermined shape, production conditions may be set and then the production conditions may be controlled. The production conditions may be allowed to have slight variations depending on each manufacturing device. Therefore, the actual manufacturing conditions are determined after optimizing the manufacturing conditions by the preliminary examination.

The production conditions for the silicon particles may be, for example, as follows. In a case where a thermal plasma method is used, silicon particles having an average particle diameter of 1 μm or more and 8 μm or less may be melted as a raw material. The average particle diameter of the raw material is one of the parameters that may affect the particle diameter of silicon particles. In addition, the parameters that may affect the shape of silicon particles may include the melting temperature, the melting time, the cooling temperature, the cooling rate, and the like. The melting temperature of silicon may be set to, for example, 1,200° C. or higher and 12,000° C. or lower. The melting time of silicon may be set to, for example, 1 second or more and 300 seconds or less. The cooling temperature for solidifying silicon may be set to, for example, 15° C. or higher and 800° C. or lower. The cooling rate in a case of solidifying silicon may be set to, for example, 5° C./s or more and 10,000° C./s or less. In a case where the cooling rate is fast, the crystallinity of the particles decreases, which makes the diffusion of lithium during charging and discharging more uniform, thereby improving the cycle characteristics of the lithium ion secondary battery. In an implementation, the cooling rate may be 1,000° C./s or more. In addition, the atmosphere in a case where silicon is melted and then cooled may be an inert atmosphere such as Ar or nitrogen. In addition, in a case of introducing molten silicon into the cooling space using a nozzle, the diameter, shape, and length of the nozzle, and the flow rate of molten silicon to the nozzle may be designed. These may also affect the shape of the silicon particles. The preliminary examination may be carried out for the diameter, shape, and length of the nozzle, and the flow rate of molten silicon to the nozzle, thereby determining the conditions that match the device.

In addition, the silicon particles may be subjected to an aging treatment. The aging treatment may be a treatment of exposing silicon particles to an environment of a humidity of 80% and a temperature of 25° C. for a predetermined period of time. The dew point during the aging treatment may be set to, for example, 21° C. As an atmosphere for carrying out aging treatment, a oxygen concentration may be 20% or more. The aging treatment may be carried out gently in an environment in which ultraviolet rays, e.g., having a strong intensity, are applied. The aging treatment can be carried out using a fluorescent lamp, LEDs, or the like, which has an appropriate wavelength. In addition, the surface of the silicon particles is oxidized in a case where the aging treatment is carried out while regularly stirring or rotating a powder.

In addition, in a case of producing silicon particles, in order to adjust the ratio of SiO₂ to Si on the silicon surface, the silicon particles may be mixed and stirred in ethylene carbonate, water, or a mixture of these. During the mixing and stirring, the surface of the silicon particles may be oxidized. As the water, for example, degassed water may be used. By using degassed water, the degree of oxidation on the surface of silicon particles can be adjusted. In addition, the degree of oxidation on the surface of silicon particles can also be adjusted by the temperature during mixing and stirring, the stirring time, and the like. The temperature during mixing and stirring may be, for example, 45 degrees. The stirring time may be set to, for example, 24 hours or more. In addition, mixing and stirring may also be carried out in a weak ultraviolet environment using a fluorescent lamp or LEDs. These lighting instruments may be placed, for example, in a solution, and stirring is carried out.

The negative electrode material according to the first embodiment may provide excellent cycle characteristics to the lithium ion secondary battery. This is considered to be because the silicon particles contain an appropriate amount of oxygen as SiO₂, which suppresses the damage to the silicon particles during the charging and discharging of the lithium ion secondary battery, and also suppresses the excessive decomposition of the electrolytic solution that is contact with the silicon.

### “Lithium Ion Secondary Battery”

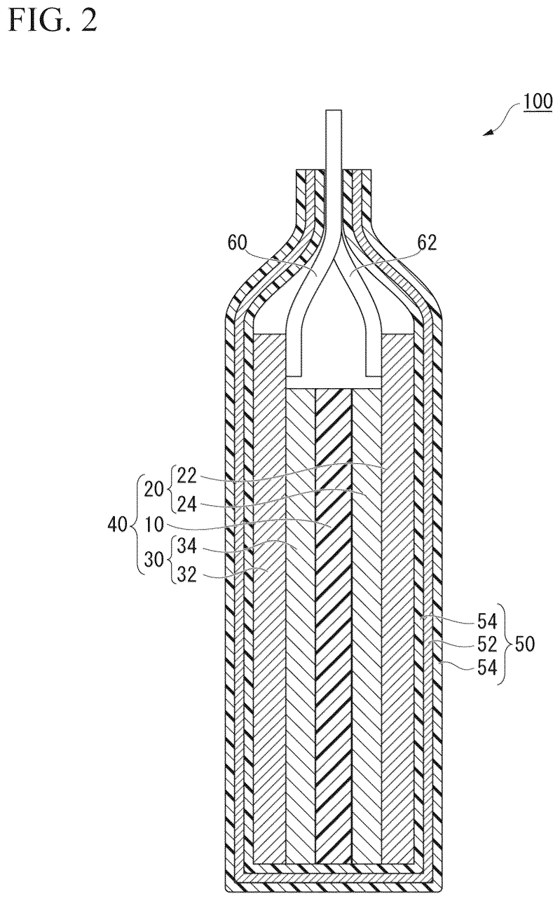

FIG. 2 is a schematic cross-sectional view of a lithium-ion rechargeable battery according to the first embodiment. A lithium-ion rechargeable battery 100 shown in FIG. 2 includes a power generation element 40, an exterior body 50, and an electrolyte (for example, a non-aqueous electrolytic solution). The exterior body 50 covers the periphery of the power generation element 40. The power generation element 40 may be connected to the outside by a pair of terminals 60 and 62 which are connected to the power generation element 40. The non-aqueous electrolytic solution is accommodated within the exterior body 50. Although FIG. 2 illustrates, as an example, a case in which one power generation element 40 is provided within the exterior body 50, a plurality of power generation elements 40 may be laminated.

### (Power Generation Element)

The power generation element 40 may include a separator 10, a positive electrode 20, and a negative electrode 30. The power generation element 40 may be a laminate in which these are laminated or may be a wound body in which a structure obtained by laminating these is wound.

### <Positive Electrode>

The positive electrode 20 may have, for example, a positive electrode current collector 22 and a positive electrode active material layer 24. The positive electrode active material layer 24 may be in contact with at least one surface of the positive electrode current collector 22.

### [Positive Electrode Current Collector]

The positive electrode current collector 22 may be, for example, a conductive plate material. The positive electrode current collector 22 may be a thin plate of a metal, for example, aluminum, copper, nickel, titanium, or stainless steel. In an implementation, aluminum, which is light in weight, may be used for the positive electrode current collector 22. The average thickness of the positive electrode current collector 22 may be, for example, 10 μm or more and 30 μm or less.

### [Positive Electrode Active Material Layer]

The positive electrode active material layer 24 may contain, for example, a positive electrode active material. In an implementation, the positive electrode active material layer 24 may also contain a conductive auxiliary agent and a binder.

The positive electrode active material layer may contain an electrode active material that enables the reversible proceeding of absorbing and releasing of lithium ions, desorbing and inserting (intercalating) of lithium ions, or doping and dedoping of lithium ions and counter anions.

The positive electrode active material may be, for example, a composite metal oxide. The composite metal oxide may be, for example, lithium cobaltate (LiCoO₂), lithium nickelate (LiNiO₂), lithium manganate (LiMnO₂), and lithium manganese spinel (LiMn₂O₄), as well as a compound of a general formula: LiNiₓCo_{y}Mn_{z}MₐO₂ (in the general formula, x+y+z+a=1, 0≤x<1, 0≤y<1, 0≤z<1, and 0≤a<1 are satisfied, and M is one or more kinds of elements selected from Al, Mg, Nb, Ti, Cu, Zn, and Cr), a lithium vanadium compound (LiV₂O₅), an olivine-type LiMPO₄ (here, M represents one or more kinds of elements selected from Co, Ni, Mn, Fe, Mg, Nb, Ti, Al, and Zr, or VO), lithium titanate (Li₄Ti₅O₁₂), and LiNiₓCo_{y}Al₂O₂ (0.9<x+y+z<1.1). The positive electrode active material may be an organic material. For example, the positive electrode active material may be polyacetylene, polyaniline, polypyrrole, polythiophene, or polyacene.

The positive electrode active material may be a lithium-free material. Examples of the lithium-free material may include FeF₃, a conjugated polymer containing an organic conductive material, a Chevrel phase compound, a transition metal chalcogenide, a vanadium oxide, and a niobium oxide. As the lithium-free material, any one material described above may be used alone, or a plurality of the materials described above may be used in combination. In a case where the positive electrode active material is a lithium-free material, for example, discharging may be first carried out. Lithium may be inserted into the positive electrode active material by discharging. In addition, the positive electrode active material as a lithium-free material may be pre-doped with lithium chemically or electrochemically.

The conductive auxiliary agent may help enhance electron conductivity between the positive electrode active materials. The conductive auxiliary agent may be, for example, a carbon powder, a carbon nanotube, a carbon material, a metal fine powder, a mixture of a carbon material and a metal fine powder, or a conductive oxide. Examples of the carbon powder may include carbon black, acetylene black, and Ketjen black. The fine metal powder may be for example, a powder of copper, nickel, stainless steel, or iron.

The content of the conductive auxiliary agent in the positive electrode active material layer 24 may be a suitable amount. For example, with respect to the total mass of the positive electrode active material, the conductive auxiliary agent, and the binder, the content of the conductive auxiliary agent may be 0.5% by mass or more and 20% by mass or less, or 1% by mass or more and 5% by mass or less.

The binder in the positive electrode active material layer 24 may bind the positive electrode active materials to each other. As the binder, a suitable binder can be used. The binder may be one that is insoluble in the electrolytic solution, has oxidation resistance, and has adhesiveness. The binder may be, for example, a fluororesin. The binder may be, for example, polyvinylidene fluoride (PVDF), polyvinyl alcohol (PVA), polytetrafluoroethylene (PTFE), polyamide (PA), polyimide (PI), polyamideimide (PAI), polybenzimidazole (PBI), polyether sulfone (PES), a polyacrylic acid and a copolymer thereof, metal ion-crosslinked products of a polyacrylic acid and a copolymer thereof, polypropylene (PP) or polyethylene (PE) which is grafted with maleic anhydride, or a mixture thereof. In an implementation, the binder that is used in the positive electrode active material layer may be PVDF.

The content of the binder in the positive electrode active material layer 24 may be a suitable amount. For example, with respect to the total mass of the positive electrode active material, the conductive auxiliary agent, and the binder, the content of the binder may be 1% by mass or more and 15% by mass or less or 1.5% by mass or more and 5% by mass or less. If the binder content were to be too low, the adhesion strength of the positive electrode 20 could be weakened. If the binder content were to be too high, the energy density of the lithium ion secondary battery 100 cold decrease since the binder is electrochemically inactive and thus does not contribute to the discharge capacity.

### <Negative Electrode>

The negative electrode 30 may have, for example, a negative electrode current collector 32 and a negative electrode active material layer 34. The negative electrode active material layer 34 may be formed on at least one surface of the negative electrode current collector 32.

### [Negative Electrode Current Collector]

The negative electrode current collector 32 may be, for example, a conductive plate material. As the negative electrode current collector 32, the same one as in the positive electrode current collector 22 can be used.

### [Negative Electrode Active Material Layer]

The negative electrode active material layer 34 may contain a negative electrode active material and a binder. In an implementation, the negative electrode active material layer may contain a conductive auxiliary agent, a dispersion stabilizer, and the like. The negative electrode active material may use the above-described negative electrode material. By using the above-described negative electrode material as the negative electrode active material, the cycle characteristics of the lithium ion secondary battery 100 may be improved.

As the conductive auxiliary agent and the binder, the same one as in the positive electrode 20 can be used. The binder in the negative electrode 30 may be, in addition to those exemplified for the positive electrode 20, for example, cellulose, styrene-butadiene rubber, ethylene-propylene rubber, a polyimide resin, a polyamide-imide resin, or an acrylic resin. The cellulose may be, for example, carboxymethyl cellulose (CMC).

### <Separator>

The separator 10 may be sandwiched between the positive electrode 20 and the negative electrode 30. The separator 10 may separate the positive electrode 20 from the negative electrode 30 and may help prevent a short circuit between the positive electrode 20 and the negative electrode 30. The separator 10 may extend in-plane along the positive electrode 20 and the negative electrode 30. Lithium ions can pass through the separator 10.

The separator 10 may have, for example, a porous structure having electrical insulating properties. The separator 10 may be, for example, a single layered body or laminate of a polyolefin film. The separator 10 may be a stretched film of a mixture of polyethylene and polypropylene. The separator 10 may be a fibrous nonwoven fabric including cellulose, polyester, polyacrylonitrile, polyamide, polyethylene, or polypropylene. The separator 10 may be, for example, a solid electrolyte. The solid electrolyte may be, for example, a polymer solid electrolyte, an oxide solid electrolyte, or a sulfide solid electrolyte. The separator 10 may be an inorganic coated separator. The inorganic coated separator may be obtained by coating the surface of the above-described film with a mixture of a resin such as PVDF or CMC and an inorganic substance such as alumina or silica. The inorganic coated separator may have an excellent heat resistance and may help suppress the precipitation of transition metals eluted from the positive electrode, onto the surface of the negative electrode.

### <Electrolytic Solution>

The electrolytic solution may be enclosed in the exterior body 50, and the power generation element 40 may be impregnated with the electrolytic solution. In an implementation, the electrolytic solution may be a liquid electrolytic solution or may be a solid electrolytic solution. The non-aqueous electrolytic solution may contain, for example, a non-aqueous solvent and an electrolytic salt. The electrolytic salt may be dissolved in a non-aqueous solvent.

The solvent may be a suitable solvent for lithium-ion rechargeable batteries. The solvent may include, for example, a cyclic carbonate compound, a chain-like carbonate compound, a cyclic ester compound, or a chain-like ester compound. The solvent may contain these compounds in a suitable mixture ratio. Examples of the cyclic carbonate compound may include ethylene carbonate (EC), propylene carbonate (PC), fluoroethylene carbonate, and vinylene carbonate. Examples of the chain-like carbonate compound may include diethyl carbonate (DEC) and ethyl methyl carbonate (EMC). An example of the cyclic ester compound may include γ-butyrolactone. Examples of the chain-like ester compound may include propyl propionate, ethyl propionate, and ethyl acetate.

The electrolytic salt may be, for example, a lithium salt. Examples of the electrolyte may include LiPF₆, LiClO₄, LiBF₄, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂) (C₄F₉SO₂), LiN(CF₃CF₂CO)₂, LiBOB, and LiN(FSO₂)₂. One kind of lithium salt may be used alone, or two or more thereof may be used in combination. From the viewpoint of the degree of ionization, the electrolyte may contain LiPF₆. The dissociation rate of the electrolytic salt in a carbonate solvent at room temperature may be 10% or more.

The electrolytic solution may be, for example, obtained by dissolving LiPF₆ in a carbonate solvent. The concentration of LiPF₆ may be, for example, 1 mol/L. In a case where the polyimide resin contains a large amount of aromatics, the polyimide resin may exhibit charging behavior similar to that of soft carbon. In a case where the electrolytic solution is an electrolytic solution that uses a carbonate including a cyclic carbonate as a solvent, lithium can be reacted uniformly with the polyimide. In this case, the cyclic carbonate may be ethylene carbonate, fluoroethylene carbonate, or vinylene carbonate.

### <Exterior Body>

The exterior body 50 may seal, in the inside thereof, the power generation element 40 and the non-aqueous electrolytic solution. The exterior body 50 may help suppress the leakage of the non-aqueous electrolytic solution to the outside, the infiltration of moisture or the like into the lithium ion secondary battery 100 from the outside.

As shown in FIG. 2, the exterior body 50 may have, for example, a metal foil 52 and a resin layer 54 laminated on each side of the metal foil 52. The exterior body 50 may be a metal laminate film that is obtained by coating the metal foil 52 on both sides with a polymer film (resin layer 54).

As the metal foil 52, for example, an aluminum foil can be used. For the resin layer 54, a polymer film such as polypropylene can be used. The material that constitutes the resin layer 54 may be different between the inner side and the outer side. For example, as a material for the outer side, a polymer having a high melting point, for example, polyethylene terephthalate (PET) or polyamide (PA) can be used, and as a material of the polymer film for the inner side, polyethylene (PE), polypropylene (PP), or the like can be used.

### <Terminal>

The terminals 62 and 60 may be connected to the positive electrode 20 and the negative electrode 30, respectively. The terminal 62 connected to the positive electrode 20 may be a positive electrode terminal, and the terminal 60 connected to the negative electrode 30 may be a negative electrode terminal. The terminals 60 and 62 may be for electrical connection to the outside. The terminals 60 and 62 may be formed from a conductive material such as aluminum, nickel, copper, or the like. The connection method may be welding or screwing. The terminals 60 and 62 may be protected with an insulating tape to help reduce or prevent short circuits.

### “Manufacturing Method for Lithium Ion Secondary Battery”

The lithium ion secondary battery 100 may be produced by producing the negative electrode 30, the positive electrode 20, the separator 10, the electrolytic solution, and the exterior body 50, and then assembling them. Hereinafter, one example of a manufacturing method for the lithium ion secondary battery 100 will be described.

The negative electrode 30 may be produced, for example, by sequentially carrying out a slurry production step, an electrode application step, a drying step, and a rolling step.

The slurry production step may be a step of mixing the negative electrode active material, the binder, the conductive auxiliary agent, and the solvent to produce a slurry. The negative electrode active material may use the above-described negative electrode material. In a case where a dispersion stabilizer is added to the slurry, it is possible to help suppress the aggregation of the negative electrode active material.

The slurry production step may be a step of mixing the negative electrode active material, the binder, the conductive auxiliary agent, and the solvent to produce a slurry. Examples of the solvent may include water and N-methyl-2-pyrrolidone. The composition ratio of the negative electrode active material, the conductive material, and the binder may be 70 wt % to 100 wt %: 0 wt % to 10 wt %: 0 wt % to 20 wt % in terms of mass ratio. The mass ratio thereof is adjusted so that the total is 100 wt %. The container to be used in a case of producing the slurry may be a container made of metal such as SUS. In a case where a polar solvent such as N-methyl-2-pyrrolidone is used as the solvent, the electrostatic capacity of the oxide film on the surface of the silicon particles may increase. A polar solvent may help prevent repulsion between the conductive auxiliary agent and the silicon particles. By suppressing the repulsion therebetween, it is possible to help prevent a decrease in the capacity of the lithium ion secondary battery.

The negative electrode active material may be a negative electrode active material obtained by mixing active material particles and a conductive material while applying shear force and then allowing them to be complexed. In a case where the active material particles are mixed by applying shear force to the extent that the active material particles do not deteriorate, the surface of the active material particles may be coated with the conductive material. In addition, the particle diameter of the negative electrode active material can also be adjusted according to the degree of this mixing. In addition, the negative electrode active material after production may also be sieved to have a uniform particle diameter.

The electrode coating step may be a step of coating the surface of the negative electrode current collector 32 with a slurry. The coating method for the slurry may include a suitable coating method. For example, a slit die coating method or a doctor blade method can be used as the coating method for the slurry. The slurry may be applied, for example, at room or ambient temperature.

The drying step may be a step of removing a solvent from the slurry. For example, the negative electrode current collector 32 on which the slurry is applied may be dried in an atmosphere at 80° C. to 350° C.

In an implementation, the rolling step may be carried out. The rolling step may be a step of applying pressure to the negative electrode active material layer 34 to adjust the density of the negative electrode active material layer 34. The rolling step may be carried out, for example, using a roll press device.

The positive electrode 20 can be produced according to the same procedure as in the negative electrode 30. As the separator 10 and the exterior body 50, commercially available ones can be used.

Next, the produced positive electrode 20 and negative electrode 30 may be laminated so that the separator 10 is located between them, whereby the power generation element 40 is produced. In a case where the power generation element 40 is a wound body, the positive electrode 20, the negative electrode 30, and the separator 10 may be wound around with one end side thereof as an axis.

Finally, the power generation element 40 may be enclosed in the exterior body 50. The non-aqueous electrolytic solution may be injected into the exterior body 50. After the non-aqueous electrolytic solution is injected, decompression, heating, or the like may be carried out to impregnate the power generation element 40 with the non-aqueous electrolytic solution. Heat or the like may be applied to seal the exterior body 50, whereby the lithium ion secondary battery 100 is obtained. It is noted that instead of injecting the electrolytic solution into the exterior body 50, the power generation element 40 may be immersed in the electrolytic solution. In an implementation, it may be allowed to stand for 24 hours after the injection of liquid into the power generation element.

The lithium ion secondary battery 100 according to the first embodiment may have excellent cycle characteristics since the negative electrode active material includes a predetermined negative electrode material.

As described above, the embodiments of the present disclosure have been described in detail with reference to the drawings. However, each of the configurations and the combination thereof in each embodiment are examples, and additions, omissions, substitutions, and other modifications of the configuration can be made without departing from the spirit of the present disclosure.

### EXAMPLES

### Example 1

A positive electrode slurry was applied onto one surface of an aluminum foil having a thickness of 15 μm. The positive electrode slurry was produced by mixing a positive electrode active material, a conductive auxiliary agent, a binder, and a solvent.

LiₓCoO₂ was used as the positive electrode active material. Acetylene black was used as the conductive auxiliary agent. Polyvinylidene fluoride (PVDF) was used as the binder. N-methyl-2-pyrrolidone was used as the solvent. 97 parts by mass of the positive electrode active material, 1 part by mass of the conductive auxiliary agent, 2 parts by mass of the binder, and 70 parts by mass of the solvent were mixed to produce the positive electrode slurry. The amount of the positive electrode active material carried in the positive electrode active material layer after drying was set to 25 mg/cm². The solvent was removed from the positive electrode slurry in the drying furnace to create a positive electrode active material layer. The positive electrode active material layer was pressed with a roll press to produce a positive electrode.

Next, a negative electrode slurry was produced. For the negative electrode active material to be added to the negative electrode slurry, silicon particles having an average particle diameter of 4.6 μm, an average circularity of 0.954, and an average aspect ratio of 0.91 were used. The silicon particles were mixed and stirred for 24 hours in a mixture of ethylene carbonate and water at 45° C. In addition, the mixing and stirring were carried out by immersing LEDs in the solution under or to provide a weak ultraviolet environment. The average particle diameter, the average circularity, and the average aspect ratio were determined by measuring 50,000 particles using a particle size distribution analyzer manufactured by Malvern Panalytical Ltd. As the aging treatment, exposure was carried out for 7 days in an environment of 25° C. and a humidity of 80%. An oxide film having an average thickness of 221 nm was formed on the surface of the silicon particles after the exposure.

Carbon black was used as the conductive auxiliary agent. A polyimide resin was used as the binder. N-methyl-2-pyrrolidone was used as the solvent. 90 parts by mass of the negative electrode active material, 5 parts by mass of the conductive auxiliary agent, and 5 parts by mass of the binder were mixed in N-methyl-2-pyrrolidone to produce the negative electrode slurry.

Then, the slurry was applied onto one side of a copper foil having a thickness of 10 μm and then dried. The amount of the negative electrode active material carried in the negative electrode active material layer after drying was set to 2.5 mg/cm². The negative electrode active material layer was pressurized with a roll press and then baked in a nitrogen atmosphere at 300° C. or higher for 5 hours.

Next, an electrolytic solution was produced. A solvent for the electrolytic solution was fluoroethylene carbonate (FEC):ethylene carbonate (EC):diethyl carbonate (DEC) in a ratio of 10% by volume:20% by volume:70% by volume. In addition, an additive for improving output, an additive for gas suppression, an additive for cycle characteristic improvement, an additive for safety performance improvement, and the like were added to the electrolytic solution. LiPF₆ was used as the electrolytic salt. The concentration of LiPF₆ was set to 1 mol/L.

### (Production of Lithium Ion Secondary Battery for Evaluation)

The produced negative electrode and positive electrode were laminated with a separator (porous polyethylene sheet) interposed between them so that the positive electrode active material layer and the negative electrode active material layer faced each other, whereby a laminate was obtained. This laminate was inserted into an exterior body made of an aluminum laminate film, and the exterior body was subjected to heat sealing except for one place on the periphery thereof, whereby a hole-closing part was formed. Then, finally, the electrolytic solution was injected into the exterior body, and then the remaining one place was subjected to heat sealing while carrying out decompression with a vacuum sealer, whereby a lithium ion secondary battery was produced. The produced lithium ion secondary battery was allowed to stand for 24 hours.

(Measurement of Capacity Retention Rate after 300 Cycles)

The cycle characteristics of the lithium ion secondary battery were measured. The cycle characteristics were measured using a secondary battery charging and discharging test device (manufactured by HOKUTO DENKO Corporation).

Charging was carried out by a constant current charging at a charging rate of 1 C (a current value at which charging is completed in 1 hour in a case where constant current charging is carried out at 25° C.) until the battery voltage reached 4.2 V, and then discharging was carried out by a constant current discharging at a discharging rate of 1.0 C until the battery voltage reached 2.5 V. The discharge capacity after the completion of the charging and discharging was detected to determine a battery capacity Q₁ before the cycle test. The battery capacity Q₁ was 3,650 mAh/g.

Regarding the battery of which the battery capacity Q₁ had been determined as above, using again the secondary battery charging and discharging test device, charging was carried out by a constant current charging at a charging rate of 1 C until the battery voltage reached 4.2 V, and then discharging was carried out by a constant current discharging at a discharging rate of 1 C until the battery voltage reached 2.5 V. The above-described charging and discharging were counted as one cycle, and 300 cycles of charging and discharging were carried out. Thereafter, the discharge capacity after the completion of the 300 cycles of charging and discharging was detected to determine a battery capacity Q₂ after 300 cycles. From the battery capacities Q₁ and Q₂ obtained as above, the capacity retention rate E after 300 cycles was calculated. The capacity retention rate E is calculated according to E=Q₂/Q₁×100. The capacity retention rate of Example 1 was 97%.

### Examples 2 to 17

Examples 2 to 17 differ from Example 1 in terms of the average particle diameter, average circularity, and average aspect ratio of the silicon particles used in the negative electrode active material, the integrated intensity ratio between the SiO₂ peak and the Si peak, the thickness of the oxide film, and the oxygen content. The average particle diameter, average circularity, and average aspect ratio of the silicon particles were controlled by changing the melting conditions and cooling conditions during the production of the silicon particles. The thickness of the oxide film and the oxygen content of the silicon particles were controlled by changing the time for the aging treatment time. The integrated intensity ratio between the SiO₂ peak and the Si peak was controlled by changing the time and temperature for mixing and stirring silicon particles in a mixture of ethylene carbonate and water.

### Comparative Examples 1 to 8

Comparative Examples 1 to 8 differ from Example 1 in terms of the average particle diameter, average circularity, and average aspect ratio of the silicon particles used in the negative electrode active material, the integrated intensity ratio between the SiO₂ peak and the Si peak, the thickness of the oxide film, and the oxygen content. The average particle diameter, average circularity, and average aspect ratio of the silicon particles were controlled by changing the melting conditions and cooling conditions during the production of the silicon particles. The thickness of the oxide film and the oxygen content of the silicon particles were controlled by changing the time for the aging treatment time. The integrated intensity ratio between the SiO₂ peak and the Si peak was controlled by changing the time and temperature for mixing and stirring silicon particles in a mixture of ethylene carbonate and water.

The results of Examples 1 to 17 and Comparative Examples 1 to 8 are summarized in Table 1 and Table 2 below.

TABLE 1

| | Average | | | | Thickness | | | |
|---|---|---|---|---|---|---|---|---|
| | particle | | | SiO₂/Si | of | | | |
| | diameter | | Average | integrated | oxide | Oxygen | Discharge | Cycle |
| | of silicon | Average | aspect | intensity | film | content | capacity | characteristics |
| | particles | circularity | ratio | ratio | (nm) | (%) | (mAh/g) | (%) |
| Example 1 | 4.6 μm | 0.954 | 0.01 | 1.3 | 221 | 3.4 | 3,630 | 97% |
| Example 2 | 5.2 μm | 0.800 | 0.86 | 1.2 | 198 | 3.2 | 3,663 | 81% |
| Example 3 | 8.3 μm | 0.990 | 0.85 | 0.5 | 42 | 1.3 | 3,754 | 78% |
| Example 4 | 7.5 μm | 0.920 | 0.60 | 1.4 | 243 | 3.7 | 3,637 | 83% |
| Example 5 | 2.3 μm | 0.985 | 0.99 | 0.9 | 132 | 2.4 | 3,702 | 84% |
| Example 6 | 0.9 μm | 0.960 | 0.80 | 0.4 | 20 | 1.0 | 3,767 | 76% |
| Example 7 | 4.6 μm | 0.950 | 0.82 | 3.0 | 600 | 8.0 | 3,430 | 79% |
| Example 8 | 6.3 μm | 0.910 | 0.97 | 2.1 | 399 | 5.6 | 3,547 | 84% |
| Example 9 | 2.3 μm | 0.988 | 0.84 | 1.7 | 310 | 4.5 | 3,598 | 83% |
| Example 10 | 5.8 μm | 0.930 | 0.65 | 1.9 | 355 | 5.0 | 3,573 | 81% |
| Example 11 | 4.8 μm | 0.954 | 0.98 | 2.5 | 488 | 6.7 | 3,495 | 83% |
| Example 12 | 0.1 μm | 0.928 | 0.38 | 1.2 | 198 | 3.2 | 3,663 | 83% |
| Example 13 | 10.0 μm | 0.976 | 0.87 | 1.3 | 221 | 3.4 | 3,650 | 86% |
| Example 14 | 1.0 μm | 0.949 | 0.91 | 1.4 | 243 | 3.7 | 3,637 | 92% |
| Example 15 | 7.0 μm | 0.937 | 0.89 | 0.9 | 132 | 2.4 | 3,702 | 90% |
| Example 16 | 6.0 μm | 0.982 | 0.83 | 0.6 | 65 | 1.5 | 3,741 | 85% |
| Example 17 | 6.2 μm | 0.961 | 0.92 | 1.5 | 265 | 4.0 | 3,624 | 91% |

TABLE 2

| | Average | | | | Thickness | | | |
|---|---|---|---|---|---|---|---|---|
| | particle | | | SiO₂/Si | of | | | |
| | diameter | | Average | integrated | oxide | Oxygen | Discharge | Cycle |
| Comparative | of silicon | Average | aspect | intensity | film | content | capacity | characteristics |
| Example | particles | circularity | ratio | ratio | (nm) | (%) | (mAh/g) | (%) |
| Comparative | 0.05 μm | 0.976 | 0.88 | 1.3 | 221 | 3.4 | 3,650 | 48% |
| Example 1 | | | | | | | | |
| Comparative | 11.2 μm | 0.949 | 0.07 | 1.2 | 198 | 3.2 | 3,663 | 59% |
| Example 2 | | | | | | | | |
| Comparative | 6.5 μm | 0.750 | 0.91 | 0.3 | 8 | 1.2 | 3,780 | 45% |
| Example 3 | | | | | | | | |
| Comparative | 3.3 μm | 0.998 | 8.89 | 0.1 | 3 | 1.1 | 3,806 | 44% |
| Example 4 | | | | | | | | |
| Comparative | 4.9 μm | 0.928 | 0.55 | 0.2 | 5 | 1.0 | 3,793 | 48% |
| Example 5 | | | | | | | | |
| Comparative | 5.6 μm | 0.976 | 0.995 | 4.5 | 935 | 12.1 | 3,236 | 51% |
| Example 6 | | | | | | | | |
| Comparative | 2.3 μm | 0.949 | 0.87 | 0.3 | 7 | 0.8 | 3,780 | 31% |
| Example 7 | | | | | | | | |
| Comparative | 6.8 μm | 0.937 | 0.91 | 3.2 | 645 | 8.6 | 3,404 | 42% |
| Example 8 | | | | | | | | |

Examples 1 to 19 had a high capacity retention rate and excellent cycle characteristics as compared with Comparative Examples 1 to 8.

In Comparison Example 1, the average particle diameter of the silicon particles was small, and the area of contact with the electrolytic solution was large. Therefore, in Comparative Example 1, it is considered that lithium has been consumed in the irreversible reaction (side reaction) between silicon and the electrolytic solution, which has reduced the capacity retention rate. In Comparative Example 2, the average particle diameter of silicon particles was large. It is considered that large silicon particles are prone to cracking during expansion and contraction, which has reduced the capacity retention rate of Comparative Example 2.

In Comparative Examples 3 to 8, the integrated intensity ratio obtained by dividing the integrated intensity of the SiO₂ peak by the integrated intensity of the Si peak was outside the predetermined range. It is not clearly revealed why the cycle characteristics of the lithium ion secondary battery deteriorate in a case where the integrated intensity ratio is outside the predetermined range. However, in any of Comparative Examples 3 to 7, the cycle characteristics were about half as compared with Examples 1 to 17, in which the integrated intensity ratio was within the predetermined range.

### REFERENCE SIGNS LIST

10 Separator
20 Positive electrode
22 Positive electrode current collector
24 Positive electrode active material layer
30 Negative electrode
32 Negative electrode current collector
34 Negative electrode active material layer
40 Power generation element
50 Exterior body
52 Metal foil
54 Resin layer
60, 62 Terminal
100 Lithium ion secondary battery

What is claimed is:

1. A negative electrode material for a lithium ion secondary battery, the negative electrode material comprising:
silicon particles,
wherein the silicon particles have an average particle diameter of 0.1 μm to 10 μm and an oxygen content of 0.1 wt % or more and 8 wt % or less, and
wherein in a case where a surface of the silicon particles is analyzed using X-ray photoelectron spectroscopy, an integrated intensity ratio obtained by dividing an integrated intensity of a SiO₂ peak by an integrated intensity of a Si peak is 0.4 or more and 3.0 or less.

2. The negative electrode material for a lithium ion secondary battery according to claim 1, wherein the integrated intensity ratio is 0.6 or more and 1.5 or less.

3. The negative electrode material for a lithium ion secondary battery according to claim 1, wherein the silicon particles have an average circularity of 0.920 or more and 0.985 or less and an average aspect ratio of 0.80 or more and 0.97 or less.

4. The negative electrode material for a lithium ion secondary battery according to claim 1,
wherein the silicon particles have an oxide film on the surface, and
wherein a thickness of the oxide film is 50 nm or more and 500 nm or less.

5. The negative electrode material for a lithium ion secondary battery according to claim 4, wherein the thickness of the oxide film is 100 nm or more and 300 nm or less.

6. The negative electrode material for a lithium ion secondary battery according to claim 1, wherein the silicon particles have an average particle diameter of 1 μm or more and 7 μm or less.

7. The negative electrode material for a lithium ion secondary battery according to claim 1, wherein the silicon particles have a silicon content of 97% or more and 99% or less.

8. A negative electrode for a lithium ion secondary battery, the negative electrode comprising the negative electrode material for a lithium ion secondary battery according to claim 1.

9. A lithium ion secondary battery, comprising:
the negative electrode for a lithium ion secondary battery according to claim 8;
a positive electrode; and
an electrolyte.
